(19) United States
(12) Patent Application Publication
(10) Pub. No.: US 2020/0095111 A1
(43) Pub. Date: Mar. 26, 2020

(54) SYSTEMS, METHODS, DEVICES AND USES THEREOF FOR MONITORING TAP HANDLES AND BOTTLES

(71) Applicant: BruVue, Inc., Apex, NC (US)

(72) Inventor: Christopher S. Lorkowski, Apex, NC (US)

(21) Appl. No.: 16/691,156

(22) Filed: Nov. 21, 2019

Related U.S. Application Data
(60) Provisional application No. 62/734,517, filed on Sep. 21, 2018.

(51) Int. Cl. B67D 1/08; B67D 1/12

(52) U.S. Cl. CPC B67D 1/0888; B67D 2210/00083; B67D 1/1277

(57) ABSTRACT

A system, method and device for monitoring fluid dispensing are described. The method includes coupling a plurality of sensors to a valve of a fluid dispensing assembly, wherein the valve is configured to operate in either a first state or a second state to control fluid flow from the inlet to the outlet. A change of a state of the valve is detected from the first state to the second state from the second state back to the first state. The detected data from the detected sequence of triggering events, a time duration and a predetermined flow rate may be transmitted through a wireless transceiver, to one or both of an external user device and a remote central monitoring unit for a determination of a volume V of fluid being dispensed.

### CROSS-REFERENCE TO RELATED APPLICATIONS

This disclosure claims priority to and the benefit of U.S. Provisional Patent Application Ser. No. 62/734,517 titled “Systems, Methods, Devices and Uses Thereof for Monitoring Tap Handles and Bottles”, filed on Sep. 21, 2018, which makes reference to international application filed PCT/US2017/028464, filed on Apr. 19, 2017, which are herein incorporated by reference in their entirety.

### TECHNICAL FIELD

This disclosure relates to monitoring content dispensing and inventory tracking, more specifically to the dispensed inventory which are in fluid state.

### BACKGROUND

Inventory tracking in a business can be quite tedious, often resulting in personnel spending a significant amount of time on a regular basis to record the amount, age, expiration, location, usage patterns, shrinkage, sales or sale pace of products. Tracking inventory is especially challenging in multi-tier supply chains where manufacturer or suppliers may need most up to date information on product movement at many commercial, retail or end user locations they may have limited or no access to. The need for this information may be driven by regulatory requirements, product planning, sales and marketing data needs. Some examples of products requiring inventory monitoring and tracking include: beer in kegs, alcoholic beverages, pesticides in sprayers, gasoline or natural gas in tanks, and pills in bottles. Take an example of beer dispensing, when one considers that a half barrel/full keg of beer is around 16 U.S. gallons (60.6 liters), one realizes that there are only about 128 one pint (0.5 liters) servings of beer in a keg. A waste of, or failure to log, 13 pint servings of keg product from a keg results in a 10% error in tracking remaining keg product via sales recordings.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals designate to corresponding parts throughout the different views.

FIG. 1 illustrates a dispensing valve assembly with a fluid monitoring and tracking device handle.

FIG. 2 illustrates another example of a dispensing valve assembly installed with an external fluid monitoring and tracking device.

FIG. 3A illustrates a perspective view of a stand-alone fluid monitoring and tracking device.

FIG. 3B illustrates a perspective view of a fluid monitoring and tracking device installed on a handle of a dispensing valve.

FIG. 4 illustrates individual fluid monitoring and tracking devices installed on respective handles of individual fluid dispensing assembly.

FIG. 5 illustrates a system diagram of a fluid monitoring and tracking device communicating with a network device.

FIG. 6 illustrates a system diagram of a fluid monitoring and tracking device communicating with a network through a remote device.

FIG. 7 illustrates an exemplary display of product inventory information.

FIG. 8 illustrates an exemplary algorithm to monitor and track fluid product inventory.

FIG. 9 illustrates an exemplary communication network to track product inventory.

FIGS. 10-14 illustrate alternate embodiments of fluid monitoring and tracking devices installed on various fluid dispensing systems.

### SUMMARY

The disclosure describes a method for monitoring fluid including coupling a plurality of sensors to a valve of a fluid dispensing assembly, wherein the plurality of sensors are housed within a tracking device housing. The fluid dispensing assembly includes a dispenser body having an inlet and an outlet, the inlet of the dispenser body is configured to be connected either to a fluid container or to a conduit that transports fluid, and the valve is disposed between the inlet and the outlet. The valve is configured to operate in either a first state or a second state to control fluid flow from the inlet to the outlet. The method further including detecting a change of a state of the valve from the first state to the second state through detecting a sequence of first triggering events, detecting a subsequent change of states of the valve from the second state back to the first state through detecting a sequence of second triggering events, determining a first time duration ΔT₁ between two successive changes of the first states of the valve and transmitting through a wireless transceiver, to one or both of an external user device and a remote central monitoring unit, first data from the detected sequence of first triggering events, second data from the detected sequence of second triggering events, the first time duration and a predetermined flow rate Q for a determination of a volume V of fluid being dispensed from the outlet of the fluid dispensing assembly.

The disclosure describes a tracking device for monitoring fluid dispensing, which includes a plurality of sensors coupled to a valve of a fluid dispensing assembly, wherein the plurality of sensors are housed within a housing of the tracking device. The fluid dispensing assembly includes a dispenser body having an inlet and an outlet, the inlet of the dispenser body is configured to be connected either to a fluid container or to a conduit that transports fluid, and the valve is disposed between the inlet and the outlet, wherein the valve is configured to operate in either a first state or a second state to control fluid flow from the inlet to the outlet. The tracking device further includes a processor housed within the housing of the tracking device. The processor executes program code stored in a memory, wherein the program code when executed, causes the processor to configure the plurality of sensors to: detect a change of state of the valve from the first state to the second state through detecting a sequence of first triggering events; detect a subsequent change of states of the valve from the second state back to the first state through detecting a sequence of second triggering events; and determine a first time duration ΔT₁ between two successive changes of the first states of the valve. The tracking device also includes a wireless transceiver, configured to transmit to one or both of an external user device and a remote central monitoring unit: first data from the detected sequence of first triggering events, second data from the detected sequence of second triggering events, the first time duration and a predetermined flow rate Q for a determination of a volume V of fluid being dispensed from the outlet of the fluid dispensing assembly.

The disclosure describes a fluid dispensing assembly that monitors fluid dispensing, which includes: a dispenser body having an inlet and an outlet, wherein the inlet of the dispenser body is configured to be connected either to a fluid container or to a conduit that transports fluid; a valve disposed between the inlet and the outlet, wherein the valve is configured to operate in either a first state or a second state to control fluid flow from the inlet to the outlet. The fluid dispensing assembly is attached with a tracking device which includes: a plurality of sensors housed within a housing of the tracking device, wherein the plurality of sensors are coupled to the valve; and a processor housed within the housing of the tracking device, that executes program code stored in a memory. The program code when executed, causes the processor to configure the plurality of sensors to: detect a change of state of the valve from the first state to the second state through detecting a sequence of first triggering events; detect a subsequent change of states of the valve from the second state back to the first state through detecting a sequence of second triggering events; and determine a first time duration ΔT₁ between two successive changes of the first states of the valve. The tracking device also includes a wireless transceiver, configured to transmit to one or both of an external user device and a remote central monitoring unit: first data from the detected sequence of first triggering events, second data from the detected sequence of second triggering events, the first time duration and a predetermined flow rate Q for a determination of a volume V of fluid being dispensed from the outlet of the fluid dispensing assembly.

### DETAILED DESCRIPTION

The disclosure describes a monitoring and tracking device that provides cost-effective way of tracking product inventory that is accurate, efficient, easy to implement, provides timely data, can operate remotely, requires minimal or no end user interaction, consumes minimal power and having a small form factor. The disclosure describes an exemplary method of analyzing dispensing or consumption of product inventory, and/or consumption trends related thereto, that is accurate, efficient, and easy to implement.

The monitoring and tracking device to be described find applications including: any valve or dispenser that connects to a container or to a supply line, which detects a product dispensing or shut off mechanism caused by a mechanical shock, or in combination with a change in magnetic field. The monitoring and tracking device may be installed in infrastructure of various dispenser types already existing and the monitoring and tracking device may retrofit without interfering with existing dispensing mechanisms in form, fit or function. The monitoring and tracking device may have low power consumption with long service life using a battery small enough to achieve monitoring the sensors and to broadcast data upon accumulating certain number of successful events.

In general, according to the present invention, data relating to the state, the use and certain contextual parameters of an inventory may be collected and transmitted, either subsequently after a duration or in real-time over an electronic network such as the Internet, to a remote site from the monitoring and tracking device for storage, later manipulation and presentation to a recipient. One or more sensors may be integrated within the monitoring and tracking device to generate signals in response to detecting dispensing events associated with a change of states in a valve of a fluid dispensing system. The generated signals may include signals generated from one or a combination of: a Mems sensor, accelerometer, gyroscope, magnetometer, biometric sensor, microphone for speech recognition, light sensor, touch sensor, motion sensor, humidity sensor, pressure sensor, proximity sensors, RFID transponder, geolocation (GPS) sensor et al.

In addition, sensor device may generate other data indicative of various conditions of a dispenser such as the location, movement information, attachment or detachment of the device to the dispenser, open or close of the dispenser, in use or our of use state of the dispenser, temperature of the dispenser or near the dispenser, orientation, timestamps of conditions or events, inventory levels, raw motion data, data derived from motion data or external conditions to the device, events derived from sensed external conditions, threading or unthreading of a dispenser handle. Sensor device generates data indicative of various conditions of the device such as the device ID, battery voltage, time since last transmission, GPS location, motion, location based on cell towers, timestamp, attachment to a dispenser, detachment from a dispenser, in-use state, out-of-use state, temperature or antenna signal strength.

In certain cases, the data indicative of the various conditions is the signal or signals themselves generated by the one or more sensors and in certain other cases the data is calculated by the microprocessor based on the signal or signals generated by the one or more sensors. Methods for generating data indicative of various conditions and sensors to be used therefor include: analyzing dispensing patterns, attachment and detachment patterns, temperature changes, or other motions of the device in order to generate data indicative of the dispenser location, dispenser performance, volume dispensed, volume remaining, dispenser maintenance, product age, product temperature, product quality, product pressure or product flow rate.

Additional data indicative of the dispenser in a draft beer system may include: the time a keg is placed in or removed from the cooler, the time the keg is tapped or untapped, the actuation of a FOB (Foam on beer device) or the resetting of a FOB.

The sensor may associate a probability or confidence level to the data, condition or event communicated. The sensor may store a library of conditions, criteria and/or event types for assessing sensed conditions. Said library may be programmed once or updated when the sensor communicates or as the sensor operates. Algorithms or decision criteria may be modified over time by data recorded by the sensors, data received from the cloud, data received from other sensors directly or via the cloud, by input directly from a user, by input from a user via the cloud or other.

The generated data from the sensor device may be communicated wirelessly in one or more schemes, including: in real-time, periodically, delayed, upon reaching a predetermined cumulative triggering events or a predetermined cumulative flow volume, in burst broadcast mode and encrypted.

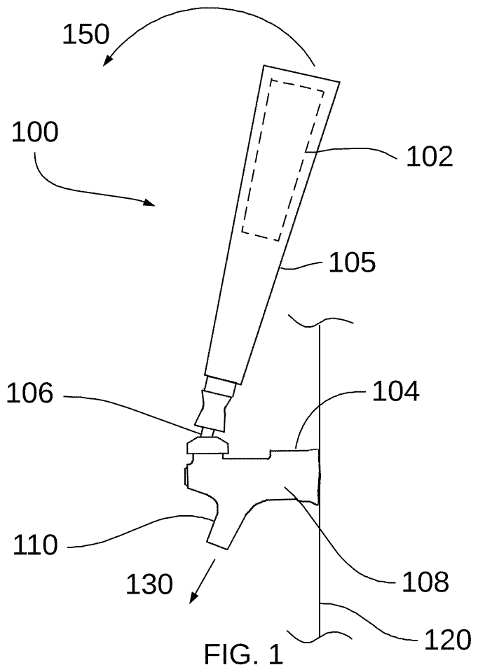

FIG. 1 illustrates a fluid dispensing assembly 100 with an integrated fluid monitoring and tracking device handle 105. The integrated fluid monitoring and tracking device handle 105 may include an embedded fluid monitoring and tracking device 102 (also known as “tracking device”) inserted within a hollow portion of the handle 105. The embedded tracking device 102 may not obstruct an actuating movement 150 of the handle 105 when dispensing fluid 130. In an example shown in FIG. 1, the fluid dispensing assembly 100 may be a beer tap apparatus attached to a wall or attached to a beer dispensing tank 120.

The fluid dispensing assembly 100 may include a dispenser body 104, a valve 106, a handle 105, an inlet 108, and an outlet 110. The inlet 108 of the dispenser body 104 is configured to be connected either to a fluid container or to a conduit that transports fluid, and the valve 106 is disposed between the inlet 108 and the outlet 110, wherein the valve is configured to operate in either a first state (open) or a second state (shut) to control fluid (such as pressurized fluid) flow from the inlet 108 to the outlet 110.

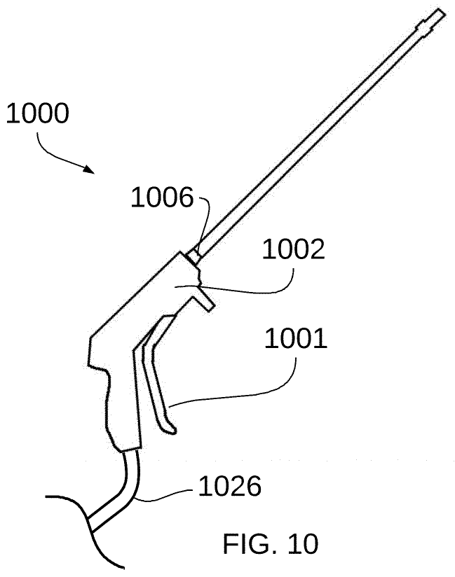

The handle 105 is a movable structure of the fluid dispensing assembly 100. In other embodiments, the movable structure may be a mechanical switch, a mechanical trigger, a lever, and a solenoid relay, and wherein the tracking device is either integrated within or externally attached to the fluid dispensing assembly (see FIGS. 10-14).

The Actuation move 150 of the handle 105 which opens valve 106 may be detected as a triggering event, which an acceleration motion is detected by an accelerometer sensor. Alternatively, the actuation movement of the handle 105 may also be detected through an angular tilt which may be detected by a gyroscope sensor or detected by a change in magnetic field through a magnetometer sensor. In another example, the triggering event may be detected as attachment or detachment of the fluid dispensing assembly 100 or the tracking device 102.

As illustrated in FIG. 1, handle 105 and tracking device 102 may be in a first state, that is, the valve 106 is closed and no fluid is dispensed. The handle 105 and the tracking device 102 may be in a second state, where the valve 106 is opened and fluid 130 is dispensed. As described below, the tracking device 102 may be configured to sense a start and a termination of a fluid dispensing event of the valve 106 through detecting a state change of a motion sensor (such as accelerometer) from a first state (valve closed—no fluid dispensed) to a second state (valve open—fluid is dispensed) and vice versa. The motion sensor detects an acceleration when the handle 105 is being set into motion from a rest position to another position. Alternately, the fluid dispensing event may be detected based on a combination of detecting exceeding a threshold of acceleration and exceeding a time duration of holding the handle 105 after being set into an initial motion to begin tracking a volume V of fluid 130 dispensed over time duration ΔT according to a calibrated or a predetermined constant fluid flow rate Q. The constant flow rate Q may be maintained by regulating a substantially constant internal pressure in the container 120 (such as the beer keg). The volume of fluid dispensed may be calculated by the equation V=Q*ΔT.

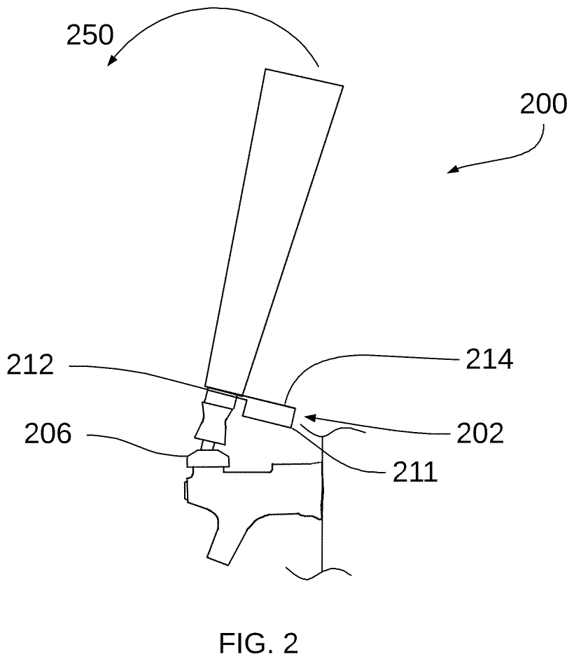

FIG. 2 illustrates an alternate embodiment of a fluid dispensing assembly 200 installed with an external fluid monitoring and tracking device 202 (i.e., tracking device). The tracking device 202 may be housed in a housing 211 and externally attached to a handle 205 through an attachment element 212. In this shown example, the housing 211 is sufficiently small without interfering an actuation movement 250 of the handle 205 for opening and closing of a valve 206. In an example, the housing 211 may be constructed from a heat conductive metal or alloy (e.g., aluminum) to allow device components housed inside the housing 211 to measure an ambient air temperature or the temperature of the fluid dispensing assembly where it contacts the housing. The housing 211 may alternately be constructed from any material, including for example a polymer, a metal, or an alloy.

In this shown example, the attachment element 212 may be an extension of a surface 214 of the housing 211. The housing 211 may be operatively connected to at least one of a product inventory storage system and a delivery system via the attachment element 212, wherein the attachment element 212 may be attached to the handle 205 by means of any one of: an opening, a hook and loop fastener, a threaded screw, a threaded recess, a snap fitting, a magnet, a hook, a ring, an adhesive, a clamp, a string, a wire, and a rope.

In addition, the tracking device 202 may include a plurality of sensors to detect a sequence of triggering events to determine a state change of the valve 206. The sensors may perform one or more of: (1) using an accelerometer to detect a sudden change of a position of a movable structure of the fluid dispensing assembly, a sudden shock force of a movable structure of the fluid dispensing assembly, a sudden change in motion of a movable structure of the fluid dispensing assembly; (2) using a magnetometer to detect a change or disruption of existing magnetic field to the movable structure of the fluid dispensing assembly; (3) using a gyroscope to detect a tilt or a change of radial angle of the movable structure of the fluid dispensing assembly; (4) using a piezoelectric pressure sensor to detect an applied pressure formed by the movable structure of the fluid dispensing assembly; (5) using a thermocouple to detect temperature change of the housing which is in contact with the fluid dispensing assembly as a result of operating the movable structure of the fluid dispensing assembly; and (6) using a photodetector to detect a disruption to an intensity of an optical beam caused by the movable structure of the fluid dispensing assembly. There may be other sensors used in the triggering event, which not limited to the scope of the disclosure.

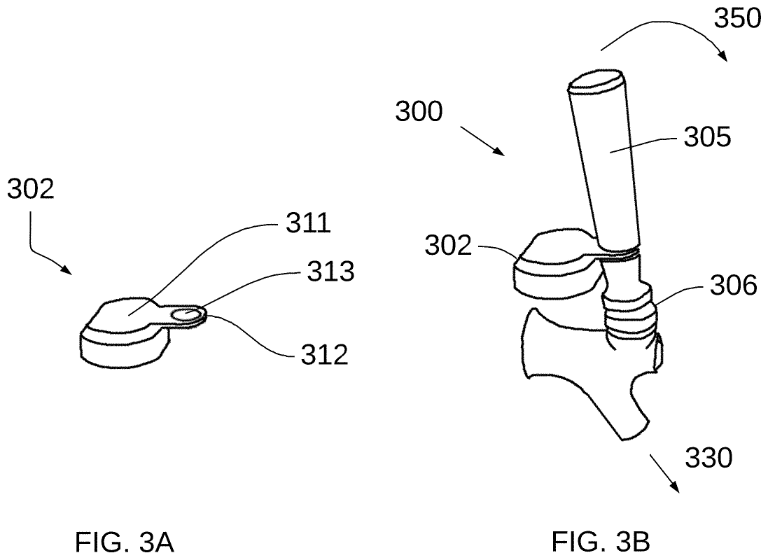

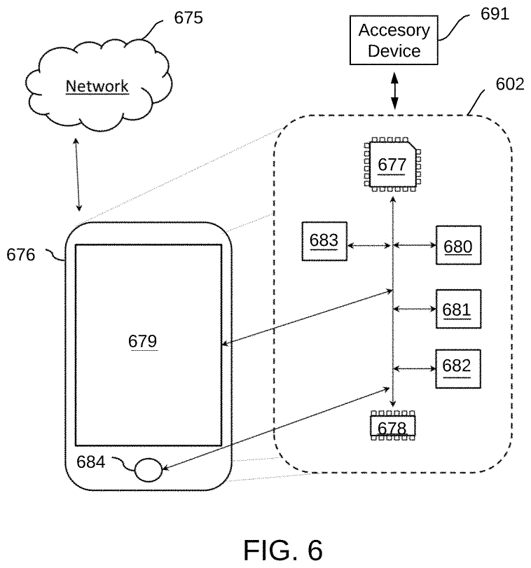

FIG. 3A illustrates a perspective view of a stand-alone fluid monitoring and tracking device 302. FIG. 3B illustrates a perspective view of a fluid monitoring and tracking device 302 installed on a handle 305 of a fluid dispensing assembly 300. As shown in FIG. 3A, the attachment element 312 may be a flange with a through hole opening 313 which may be a structural extension from the housing 311. As shown in FIG. 3B, the tracking device 302 is externally attached to the handle 305 through coaxially inserting and threading a valve portion 306 of the fluid dispensing assembly 300 through the hole opening 313 into the handle 305. Housing 311 may house a circuit board having a plurality of device components to monitor and track fluid dispensing, as further described in FIG. 6. In operation, the tracking device 302 may sense an actuation motion 350 of the handle 305 to trigger a change of state of a valve 306 to start dispensing fluid 330.

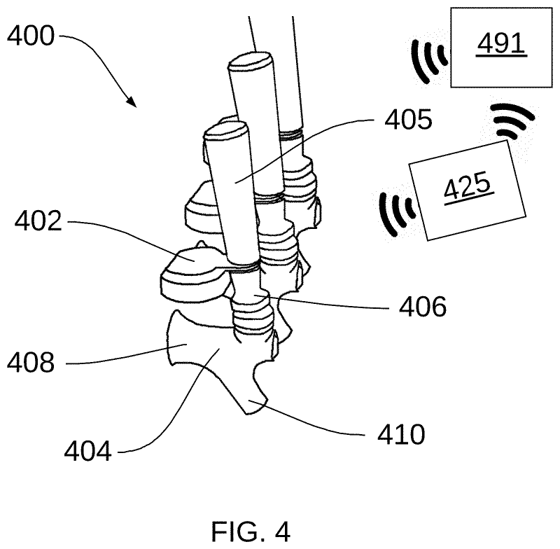

FIG. 4 illustrates individual fluid monitoring and tracking devices 402 installed on respective handles 405 of individual fluid dispensing assembly 400, such as a beer tap apparatus. In an alternate embodiment, the tracking device 402 may utilize other sensors other than a motion detector sensor (e.g. accelerometer). For example, the tracking device 402 may include a touch sensor which detects a change of capacitance when touched or a near field proximity sensor which operates inductively by reading a code from a RFID transponder 425 in order to control opening and closing of individual valve 406 in the individual fluid dispensing assembly 400. For example, the valve 406 may be controlled to open or shut by a touch of a hand on the handle 405 or a touch on the housing 411 of the tracking device 402, or through placing a RFID transponder 425 proximal to the tracking device 402 to unlock the valve 406 to dispense fluid from the container.

To add assurance to the detecting of the sequence of triggering events to open the valve to dispense fluid, an accessory device 491 may be coupled to the fluid dispensing assembly 400 and to the tracking device 402 to perform user verification prior to receiving the permission to dispense fluid. The accessory device may be a smart device having a display, a touch screen, a scanner and a near-field transponder to perform one or more of the verification methods as follows: (1) receiving user's biometric data on a biometric input device through detecting one of: finger prints, e-signature, voice signature; (2) scan in user's one-dimensional or two-dimensional (QR) barcode; (3) read a code from a user's RFID tag; and (4) receive on a touch screen, one or both of user's finger gesture and a user's password.

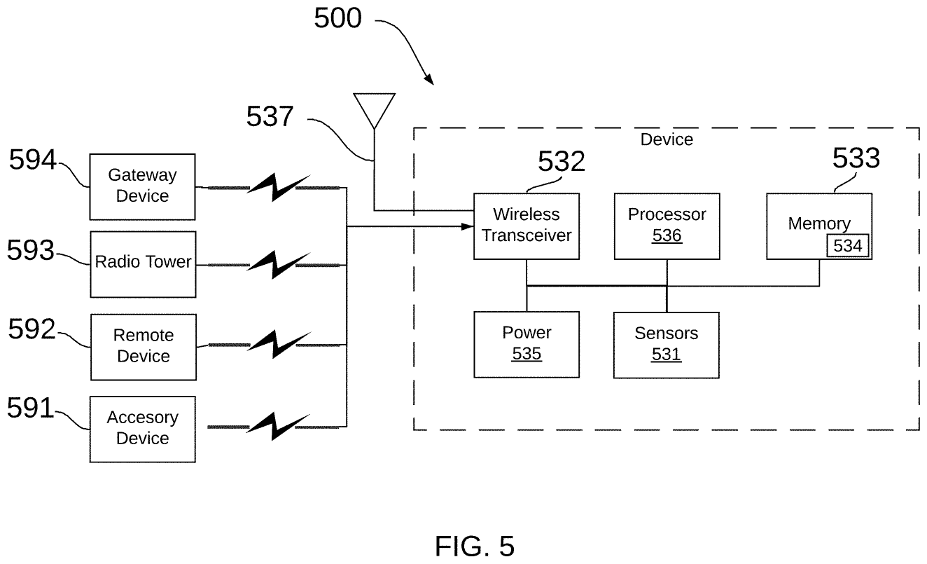

FIG. 5 illustrates a system diagram of a fluid monitoring and tracking device 500 communicating with a plurality of network devices 591-594. Any of the aforementioned tracking devices (102, 202, 302, 402) may include device components 531-537 housed within respective housings 211-411. The device components may include one or more sensor 531, a wireless transceiver 532 including an antenna 537, a memory 533 which stores executable program code, sensor data and a database 534, a power source 535 and a processor 536 operatively connected to the wireless transceiver 532. The power source 535 may be a battery which supplies direct current (dc) to power the one or more sensor 531, wireless communication device 532, and memory 533. In an embodiment, the one or more sensor 531 may be at least one or a combination of: an accelerometer for sensing an acceleration or an abrupt motion, a magnetometer for sensing a change in magnetic field or detection of a non-uniform magnetic field, a gyroscope for sensing a relative change in radial angles, a motion sensor for sensing movement, a touch sensor which senses a change of capacitance due to touch or a near field proximity sensor which may communicate inductively to read address code from a RFID tag. A combination of sensors 631 may be configured to perform both monitoring function of fluid flow and control function to open and close the valve 406 of the individual fluid dispensing assembly 400. A timer (built into the processor 536) may be used to monitor a duration of fluid flow in order to provide a reading of how much inventory has been dispensed and to track remaining inventory in a container.

As shown in FIG.5, an accessory device 591 may be one of the network devices which may be communicatively coupled to the fluid dispensing assembly 400 and to the tracking device 402 to perform user verification prior to receiving the permission to dispense fluid.

The wireless communication device 532 may be in a standby state (i.e., low power or sleep mode) or in an operating state. The memory 533 may include a nonvolatile semiconductor memory. In an example, upon sensor 531 sensing a trigger condition (such as an actuation of handle 306) which indicates opening of the valve 306, sensor 531 may store sensed condition in the memory 533 and send a command to the wireless communication device 532 to transmit the recorded sensed condition. Wireless communication device 532 may, upon receiving the command from the sensor 531, transition from a standby state to an operating state to transmit the sensed condition, then transition back to the standby state. The standby state may consume just sufficient power from power source 535 for wireless communication device to receive and interpret the command from the sensor 531, but may consume an insufficient quantity of power from power source 535 than is needed for wireless communication device 532 to communicate wirelessly. The operating state may consume a sufficient quantity of power from power source 535 for wireless communication device 532 to communicate wirelessly.

When sensor 531 is “on” during the standby state of wireless communication device 532, sensor 531 may draw less power than wireless communication device 532 in wireless communication device 532′s operating state. In this manner, power may be conserved to extend the life of power source 535.

In one embodiment, sensor 531 may be in an interrupt state to draw minimal power from power source 535. Sensor 531 may draw less power in operating state than wireless communication device 532 in operating state. In this manner, power in power source 535 may be conserved, thus increasing the life of power source 535.

In other embodiment, the wireless transceiver 532 may wake up from a low power sleep mode upon detecting one or both of: a sequence of triggering events and the verification of user's identity. Subsequent to the waking up, the wireless transceiver delays transmission to one or both of the external user device and the remote central monitoring unit until a buffer of the tracking device has reached a predetermined storage level as a result of successive counts of detection of data from the detected sequence of triggering events, and the time duration ΔT.

Wireless communication device 532 may communicate over a range of radio frequency spectrum. Wireless communication device 532 may communicate via any known wireless communication method. Wireless communication device 532 may include at least one of: a transmitter, a receiver, a transceiver, and an antenna 537. The wireless communication device 532 may transmit the recorded sensed condition or sensed data to a wireless network 675. The network 675 may be one of: an Internet through a gateway device, a cellular network through a radio tower or a cellular tower, and a local network through a remote device as shown in FIG. 6. The network may be a wireless network.

In addition, sensor 531 may further include at least one of: a liquid quantity sensor to sense a quantity of liquid passing through a system, a liquid flow sensor to sense the flow of a liquid through a system, a motion sensor to sense motion of tracking device 102 to 402, an orientation sensor to sense the orientation of tracking device 102 to 402, an accelerometer (or other binary position sensor) to sense movement and/or orientation of tracking device 102, 202, 302, an accelerometer to sense shock or vibration of tracking device 102 to 402, a gyroscope to sense movement and/or orientation of tracking device 102 to 402, a global positioning system sensor to sense movement and/or orientation of tracking device 102, 202, 302, a magnetometer to sense movement and/or orientation of tracking device 102, 202, 302 relative to a magnetic field, a force sensor to sense force applied to tracking device 102 to 402, a pressure sensor to sense pressure of a fluid passing through a system and/or pressure applied to tracking device 102, 202, 302, a light sensor to sense movement of tracking device 102 to 402, a radio frequency identification (RFID) sensor to sense proximity of a user and/or identify a particular user, a temperature sensor to sense the ambient temperature in the area of tracking device 102 to 402 and/or the temperature of a fluid passing through a system, a microphone to sense fluid mass and/or fluid flow, and a camera to visually recognize the position of handle 105, 205.

Sensor 631 may be calibrated for each application of tracking device 102 to 402. Sensor 631 may, for example, sense the tipping of handle 105 and thus opening of valve 106, 406. A user may install sensor in a fluid dispensing assembly 100 to 400, open valve 106, 406, and dispense a known quantity of fluid into a container of a known volume. Sensor 631 may sense the time between which valve 106 is opened and closed and thus the amount of time during which valve 106, 406 is opened. A user may calculate the volume of fluid dispensed during that amount of time, divide that volume by the amount of time recorded, and obtain a volume flow rate. This volume flow rate may be input into tracking device 102 to 402 via an input element described herein, such that tracking device 102 to 402 and sensor 631 is calibrated to the specific volume flow rate associated with that fluid dispensing assembly 100 to 400. Alternatively, a user may simply input the volume of fluid dispensed during the sensed time interval, and tracking device 102, 202, 302 may perform the necessary calculation to determine the volume flow rate associated with that fluid dispensing assembly 100 to 400.

Fluid dispensing assembly 100 to 400 may experience inconsistency in the volume flow rate of dispensing of a product over time. For example, volume flow rate may change as product within the product storage container (such as a beer keg) is diminished. As a result, tracking device 102 to 402 and/or remote device 775 and/or the central monitoring unit 1001 may apply a known curve to estimation of volume of product dispensed to account for this change, and may adjust recorded dispensed product volumes accordingly.

Fluid dispensing assembly 100 to 400 may experience inconsistency in the volume flow rate of dispensing of a product due to inconsistent opening of valve 106, 406. That is, where a user, such as a bartender, does not open valve 106, 406 completely, fluid may not be dispensed at the calibrated volume flow rate. Sensor 631 may sense how far valve 106, 406 is opened, for example by how far handle 105, 405 is actuated during product dispensing. Tracking device 102 to 402 and/or remote device 775 may sense a failure to open valve 106, 406 completely, and may at least one of: alert the user (e.g., bartender) to open valve 106, 406 completely, and adjust the calculated product dispensed volume to account for failure to open valve 106, 406 completely.

Tracking device 102 to 402 may alternately be integrated with a wireless temperature sensor located in a product storage area (e.g., a cooler) and alert a user if storage temperatures are not within a desired threshold. Tracking device 102 to 402 may integrate with a wireless CO2 regulator sensor operatively connected to a CO2 supply connected to fluid dispensing assembly 100 to 400, and alert a user if CO2 pressures/supplies are not within a desired threshold. Tracking device 102 to 402 may integrate with a wireless gas regulator sensor operatively connected to a gas supply connected to fluid dispensing assembly 100 to 400, and alert a user if gas pressures/supplies are not within a desired threshold.

The gas may include any gas commonly used to pressurize a fluid to be dispensed, including for example, CO2, N2, O2, atmospheric air, and the like. The gas may include any gas commonly used to pressurize a fluid to be dispensed, including for example, CO2, N2, O2, atmospheric air, and the like. Tracking device 102 to 402 may be integrated with a wireless sensor operatively connected to a keg or keg coupler connected to fluid dispensing assembly 100, 400, and alert a user if a keg is changed. Tracking device 102 to 402 may be integrated with a wireless sensor operatively connected to a lid, cap, handle or other component connected to fluid storage assembly and alert a user if the storage assembly is opened or refilled. Tracking device 102 to 402 may be integrated with a sensor including at least one of: a temperature sensor configured to measure a temperature of a product in product storage, a temperature sensor configured to measure a temperature of a product in a product delivery system, a keg or keg coupler sensor configured to measure a status or condition of a keg, a lid, cap or handle sensor configured to measure the opening and closing or refilling of a storage container and a gas regulator sensor configured to measure a pressure of a gas supply operatively connected to the product delivery system. In this manner, tracking device 102 to 402 and/or remote device 775 and/or central monitoring unit 1001 may provide a user with a general “system health” analysis.

FIG. 6 illustrates a system diagram of a fluid monitoring and tracking device 702 communicating with a network 710 through a remote device 776. The remote device 776 may include a smart phone. The description provided herein regarding smart phone 776 is for clarity, and is not intended to limit the description to any specific machine. Various machines can be utilized without departing from the scope of the embodiments described herein such as, for example, a mobile phone, a tablet computing device, a smart watch, a computer, a laptop computer, a desktop computer, or a specialized machine having communication capability.

The smart phone 776 may include one or more processors 777 for executing machine readable instructions to perform functions according to the methods described herein. As used herein, the term “processor” may mean any device capable of executing machine readable instructions. Accordingly, each processor may be a controller, an integrated circuit, a microchip, or any other device capable of implementing logic. Specific examples of the one or more processors 777 may include a touch screen controller, a baseband controller, a graphics processor, an application processor, an image processor, and the like.

Smart phone 776 may include a memory 778 communicatively coupled to the one or more processors 777 (generally depicted as double arrowed lines). As used herein, the phrase “communicatively coupled” may mean that components are capable of exchanging data signals with one another such as, for example, electrical signals via conductive medium, electromagnetic signals via air, optical signals via optical waveguides, quantum entanglement, and the like. Memory 778 described herein may be RAM, ROM, a flash memory, a hard drive, or any device capable of storing machine readable instructions. Accordingly, smart phone 776 may implement a mobile operating system as machine readable instructions stored on memory 778 and executed by the one or more processors 777. Specific examples of mobile operating systems include, but are not limited to, Android, iOS, Blackberry OS, Windows Phone, Symbian, and the like.

Additionally, the functions, modules, and processes described herein may be provided as machine readable instructions stored on memory 778 and executed by one or more processors 777. The machine readable instructions may be provided in any programming language of any generation (e.g., 1GL, 2GL, 3GL, 4GL, or 5GL) such as, e.g., machine language that may be directly executed by the processor, or assembly language, object-oriented programming (OOP), scripting languages, microcode, etc., that may be compiled or assembled into machine readable instructions and stored on a machine readable medium. Alternatively, the functions, modules, and processes described herein may be written in a hardware description language (HDL), such as logic implemented via either a field-programmable gate array (FPGA) configuration or an application-specific integrated circuit (ASIC), and their equivalents. Accordingly, the functions, modules, and processes described herein may be implemented in any conventional computer programming language, as pre-programmed hardware elements, or as a combination of hardware and software components.

Smart phone 776 may include a display 779 communicatively coupled to the one or more processors 777 for providing optical signals and conveying visual feedback to users of smart phone 776. In some embodiments, display 779 may be configured to selectively illuminate a plurality of pixels to provide the optical signals. Accordingly, display 779 may include light emitting diodes (LED or OLED), liquid crystal display (LCD), liquid crystal on silicon (LCOS), and the like. Additionally, display 779 may be configured to operate as a touch screen for accepting tactile input via visual controls. Accordingly, display 779 may include a touch detector such as, for example, a resistive sensor, capacitive sensor, and the like. The term “signal,” as used herein, may mean a quantum state or a waveform (e.g., electrical, optical, magnetic, or electromagnetic), such as DC, AC, sinusoidal-wave, triangular-wave, square-wave, and the like, capable of traveling through a medium. The term “optical” may refer to various wavelengths of the electromagnetic spectrum such as, but not limited to, wavelengths in the ultraviolet (UV), infrared (IR), and visible portions of the electromagnetic spectrum.

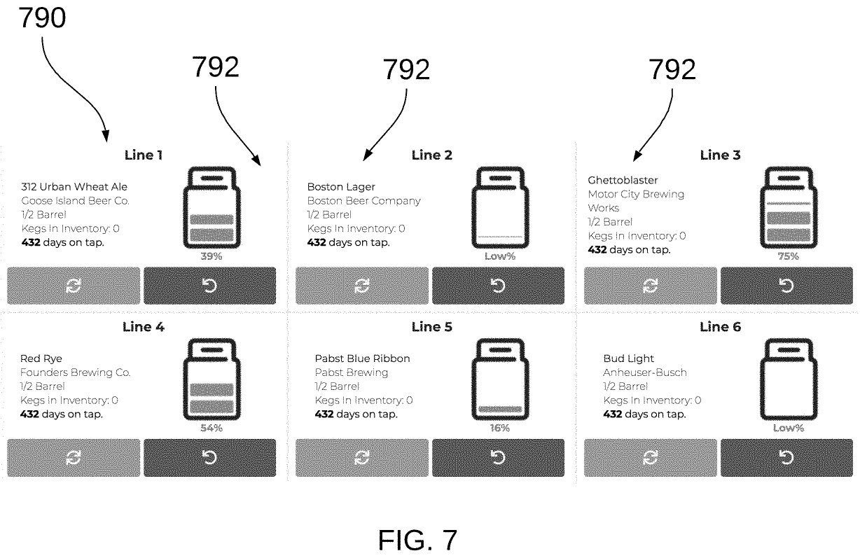

Referring still to FIG. 7, the smart phone 776 may include a network interface hardware 780 communicatively coupled to the one or more processors 777 for communicatively coupling smart phone 776 to another device via a network such as, for example, a wide area network, a local area network, personal area network, a global positioning system and combinations thereof. Accordingly, network interface hardware 780 may be configured to communicate, i.e., send and/or receive data signals via any wired or wireless communication protocol. For example, network interface hardware 780 may include an antenna, a modem, a LAN port, a wireless fidelity (Wi-Fi) card, a WiMax card, a near-field communication hardware, a satellite communication hardware, and the like. Accordingly, smart phone 776 may be communicatively coupled to a network via wires, via a wide area network, via a local area network, via a personal area network, via a satellite network, and the like. Suitable local area networks may include wired Ethernet and/or wireless technologies such as, for example, Wi-Fi. Suitable personal area networks may include wireless technologies such as, for example, IrDA, BLUETOOTH, Wireless USB, Z-WAVE, ZIGBEE, and the like. Alternatively or additionally, suitable personal area networks may include wired computer buses such as, for example, USB and FIREWIRE. Thus, any components of smart phone 776 may utilize one or more network components to communicate signals via the Internet or the World Wide Web.

Smart phone 776 may include a radio frequency hardware (RF hardware) 781 communicatively coupled to the one or more processors 777 for communicatively coupling smart phone 776 with a cellular network. Suitable cellular networks include, but are not limited to, technologies such as LTE, WiMAX, UMTS, CDMA, and GSM. In some embodiments, RF hardware 781 may include components suitable for communicating voice information and data signals such as, for example, modems, attenuators, antennas, antenna switches, amplifiers, receivers, transceivers, or combinations thereof. Accordingly, smart phone 776 described herein may utilize a cellular network to communicate signals over the Internet or the World Wide Web.

RF hardware 781 may include a receiver configured to receive a sensed condition from wireless communication device 632. RF hardware 781 may include a receiver configured to receive a sensed condition from a network. RF hardware 781 may include a receiver configured to receive a sensed condition from wireless communication device 632 via a network intermediary. The network may be a wireless network. RF hardware 781 may include a receiver configured to receive a sensed condition from wireless communication device 632 and from a network.

Memory 778 may be configured to store a sensed condition received by RF hardware 781. Display 779 may display the sensed condition received by RF hardware 781.

Smart phone 776 may include a Global Positioning System (GPS) receiver 782 communicatively coupled to the one or more processors 777. GPS receiver 782 may be configured to provide signals indicative of the location of smart phone 776. Specifically, GPS receiver 782 may receive signals encoded with location data, time data or both from a plurality of GPS satellites, when GPS receiver 782 has a substantially unobstructed line of sight to the GPS satellites.

Referring still to FIG. 6, smart phone 776 may include an optical sensor 783 communicatively coupled to the one or more processors 777 for detecting optical signals and encoding the detected signals into an image or collection of images (e.g., video). In some embodiments, optical sensor 783 may include semiconductor charge-coupled devices (CCD), complementary metal-oxide-semiconductors (CMOS), N-type metal-oxide-semiconductors (NMOS), and the like. Accordingly, one or more images may be captured by optical sensor 783 and stored in memory 778.

Smart phone 776 may include one or more input device 784 for sensing input and encoding the input into a signal indicative of the input. Suitable examples of input device 784 may include a microphone, a button, a knob, a switch, a resistive sensor, a capacitive sensor, a microphone, a keyboard, and the like. Alternatively or additionally, display 779 may be configured to receive user input and operate as input device 784. Alternatively or additionally, display 779 may be a portion of a graphical user interface configured to receive user input. In addition to the aforementioned components, smart phone 776 may include one or more additional components communicatively coupled to the one or more processors 777 without departing from the scope of the embodiments described herein. Suitable additional components include, but are not limited to, speakers, accessory lights (e.g., LED), motion sensors, and the like.

Alternatively or additionally, remote device 775 includes a graphical user interface comprising a series of user controls such as input fields, sliders, radio buttons, and the like to allow a user to program and/or configure the system. The graphical user interface may allow a user to interact with the system. The graphical user interface may be configured to permit a user to control at least one of tracking device 102 to 402 and remote device 775. Input device 784 may be configured to allow a user to control the graphical user interface.

Alternatively or additionally, remote device 775 includes an audio user interface comprising voice recognition software configured to receive a user's voice commands and allow a user to interact with the system. The audio user interface may be configured to permit a user to control at least one of tracking device 102 to 402 and remote device 775. Input device 784 may be configured to allow a user to control the audio user interface. In addition to, or as an alternative to, display 779, remote device 775 may provide a user with data regarding product conditions, product inventory, and the like, via audio output.

Remote device 775 may be configured to authenticate and communicate with at least one of: a social media account, a product procurement account, an electronic mail account, an Internet service provider account, a local area network user account, and a cellular voice and/or data account. For example, information about the high rate of distribution of a specific product may be shared via a social media account, so as to convey to subscribers of that social media account the popularity of that product. Additionally, for example, information regarding product consumption and product remaining in inventory may be transmitted to a product procurement account to request that a supplier provide additional product for inventory or replacement. For example, information regarding product consumption and/or product remaining may be transmitted via an, or to an, electronic mail account to notify a user regarding the consumption rate of the product, remaining product, or any additional properties of the product (e.g., temperature) that may be useful to the user and described herein. Additionally, for example, information about the product may be distributed to a cellular voice account and/or cellular data account to notify a user regarding properties of the product, trends, and the like.

FIG. 7 illustrates a sample display 890 of product information. Display 890 may illustrate details 892 about individual fluid dispensing assembly 100 to 400, including values of remaining product (e.g., percentage or volumes), the amount of time that a particular product has been available for dispensing (e.g., number of days), recommended actions (e.g., change keg out due to low volume or time that the particular product has been available for dispensing, where product is perishable, and any desired details related to that particular product dispenser (e.g., tap details).

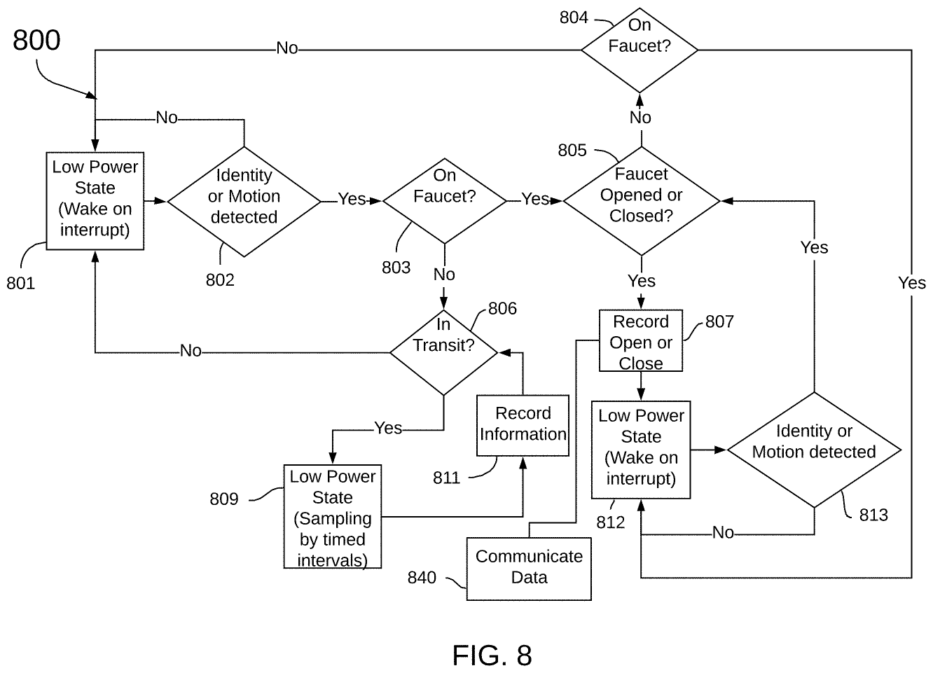

FIG. 8 illustrates an exemplary method 900 to monitor and track fluid product inventory.

Method 900 may include the steps of: (a) detecting motion or external condition of the device using the sensor to wake up from low power state (steps 901, 912); (b) in response to detecting the motion in (a), operating the device (accelerometer or other sensor) in a mode configured to detect coupling of the tap monitoring device to a beer faucet (steps 902, 913); and (c) upon determining via the attachment detection mode that the device is attached to the beer faucet, operating the accelerometer or other sensor in a first mode configured to determine one or more characteristics of the faucets or valves actuation frequency (steps 903, 904), and wherein operations (b) and (c) are carried out by a processor.

Method 900 may further include: transmitting a signal (step 940) at a regular or increasing or decreasing frequency where this signal may include 1 or more of the device ID, battery voltage of the device, attachment status of the device, time since last transmission or sensed condition, location of the device, or other status of the device, dispenser or inventory.

The steps of 902, 913 may further include: using the tracking device to: sense a condition of at least one of: change in magnetic field, shock, vibration, acceleration, change in orientation, coordinate acceleration, rotation, tilt, random motion, rotary motion, curvilinear motion, rolling motion, oscillation, projectile motion, combination motion, change in sound, change in light, button press or a signal from another physical or mechanical interface or change in temperature, record the sensed condition to the tracking device memory, and transmit the sensed condition with the wireless communication device.

The step of 940 (communicate data) in method 900 may further include: using the remote device to: receive the sensed condition from the tracking device, and record the sensed condition to the remote device memory.

Additionally, the steps 901, 912 (i.e., low power state) may include: the standby state of the tracking device consuming a sufficient quantity of power from the power source for the communication device to receive and interpret the command from the sensor, but consuming an insufficient quantity of power from the power source than is needed for the communication device to communicate wirelessly. The method may further include; the operating state of the tracking device consuming a sufficient quantity of power from the power source for the communication device to communicate wirelessly.

Additionally, the remote device used in the method 900 may be at least one of: a smart phone, a tablet computing device, a smart watch, and a computer. The remote device may be configured to both authenticate and communicate with at least one of: a social media account, a product procurement account, an electronic mail account, an Internet service provider account, a local area network user account, a cellular voice and/or cellular data account, and a remote database.

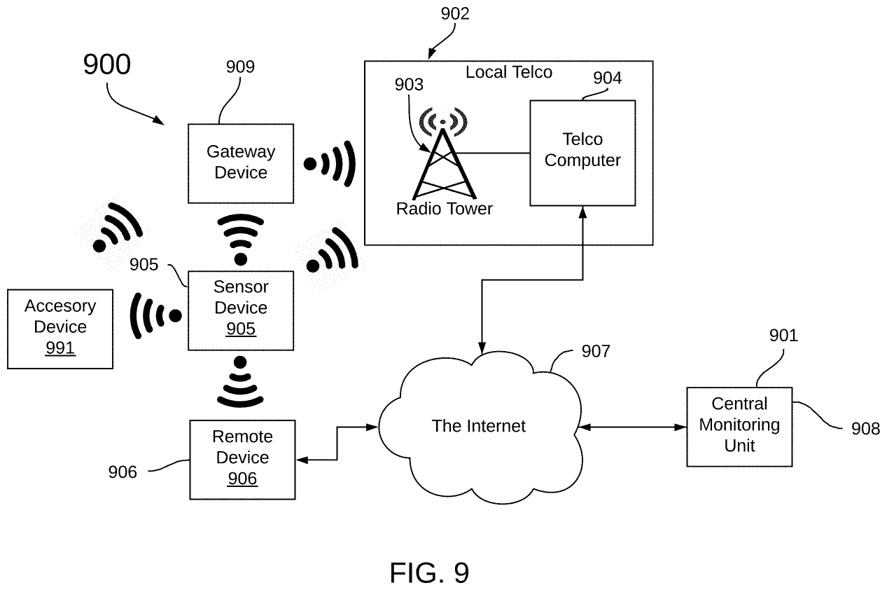

Additionally, the step of 940 (communicate data) may include: posting a message to the social media account; transmitting an order for an additional product to the product procurement account; and/or transmitting a message to at least one of: the electronic mail account and the cellular voice and/or cellular data account. The method may include recording the sensed condition to a remote database (see central monitoring unit 1001 in FIG. 9).

Tracking device 102 to 402 may communicate with the remote device 775 and display any of a variety of outputs as desired. For example, remote device 775 may display an amount of volume remaining in a specific supply of product by knowing a duration of time that fluid was dispensed and a volume flow rate of the specific fluid dispensing assembly 100 to 400 from which the fluid was dispensed. A user (e.g., owner or a manager of the operation) may be provided with an estimated date of depletion of product so as to facilitate ordering of replacement product in a well-timed manner. In another example, remote device 775 may display a graph showing the popularity of a specific product over a given time period, for example by displaying the volume of product dispensed each day within the given time period. Remote device 775 may display trends associated with the dispensing of a specific product over a given period of time.

In one embodiment, a representative of a supplier, a manager, or otherwise a user of the system described herein may log into software (e.g., SaaS software) to review the current inventory and/or events triggered by sensor 631, and set rules for alerts based upon depletion rates of product inventory, or other events. These alerts can be communicated as described above, including via a cellular data account, and transmitted to any of the accounts described above, including a cellular phone. Additionally, alerts can be pop up push alerts that are part of a smart phone, emails, voice alerts transmitted to a cellular phone, and the like. Additionally, alerts may trigger flashing lights in fluid dispensing assembly 100 to 400 (e.g., within tracking device 102 to 402), flashing lights in point of sale terminals/cash registers, and the like.

Use of tracking devices 102 to 402 on fluid dispensing assembly 100, 400 may be used to deter loss associated with users, such as bartenders, not recording volumes of product dispensed within point of sale terminals/cash registers. Use of tracking device 102 to 402 on fluid dispensing assembly 100 to 400 may be used to train users, such as bartenders, on the proper quantity of product to dispense and/or the proper method of dispensing a product.

FIG. 9 illustrates an exemplary communication system 1000 to track product inventory. A remote central monitoring unit 1001 may generate analytical status data from fluid flow data generated from a tracking device with sensors 1005. The central monitoring unit 1001 also may include a data storage device for storing the data it receives and generates. The central monitoring unit 1001 may store the data transmitted by the tracking device 1005 wherein the data from the sensor may be combined with external data via an API, import, upload or other method from a point of sale system, inventory log, prescription instructions or other location. The data may be used to compare actual product movement to documented or intended product movement.

The central monitoring unit 1001 may process data immediately upon receipt or it may store data for processing at a later time. Central monitoring unit 1001 may cleanse, filter, sort, combine, manipulate, separate, flag or perform other operations on the data it receives. Central monitoring unit 1001 may process data individually or in aggregate in order to determine 1 or more data indicative of a product. Examples of data indicative to the product inventory include: the product performance, product location, volume dispensed, volume remaining, dispenser maintenance, product age, product temperature, product quality, product pressure, product flow rate, dispenser location or dispenser performance.

The central monitoring unit 1001 may also communicate with a network of other devices at a point of sale (i.e., a restaurant or lounge), such as bar manager's remote device 775, a store neon sign, a cooler or other components of an inventory system. Such communications may be used to inform the patron of timely or important product offers or rewards via text message, email, push notification or other electronic notification means. The central monitoring unit 1001 may detect product theft patterns, product spoilage, product outages, product trends, product misuse, low product quality, product waste, slow product movement, tap handle theft, beer foaming or other.

The central monitoring unit 1001 may communicate information to the tracking device 1005 to modify or control operation such as shut off a valve in case of spillage. The central monitoring unit 1001 may send data or commands to the tracking device 1005 including firmware, data libraries, variables, algorithms. The central monitoring unit 1001 may provide information to dashboards or websites for a user or for a technical team such as an IT team in order to manage the tracking device 1005 and their statuses. The dashboards or websites may display analytical data based on the data the central monitoring unit 1001 stores or processes. Central monitoring unit 1001 may also send data to websites via API's.

Furthermore, in addition to collecting data by automatically sensing such data in the manners described above, individuals such as business owner, bar manager or restaurant manager may also manually provide data relating to various inventory activities that is ultimately transferred to and stored at central monitoring unit 1001. An individual user can access a web site maintained by central monitoring unit 1001 and can directly input information relating to inventory activities by entering text freely, by responding to questions posed by the web site, or by clicking through dialog boxes provided by the web site. Central monitoring unit 1001 can also be adapted to periodically send electronic mail messages containing questions designed to elicit information relating to inventory activities to the remote device 775 or to some other device that can receive electronic mail. Such as a personal digital assistant, a pager, or a cellular phone. The individual would then provide data relating to inventory activities to central monitoring unit 1001 by responding to the appropriate electronic mail message with the relevant data.

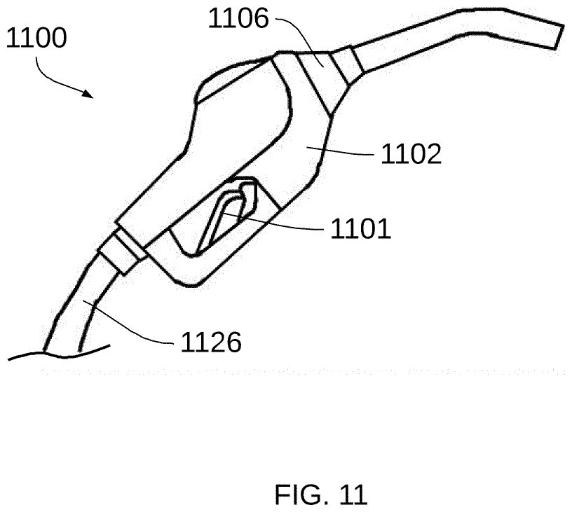

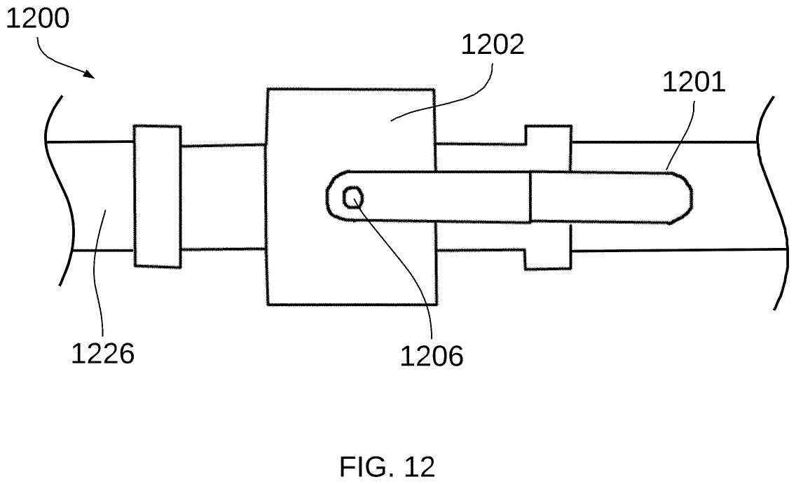

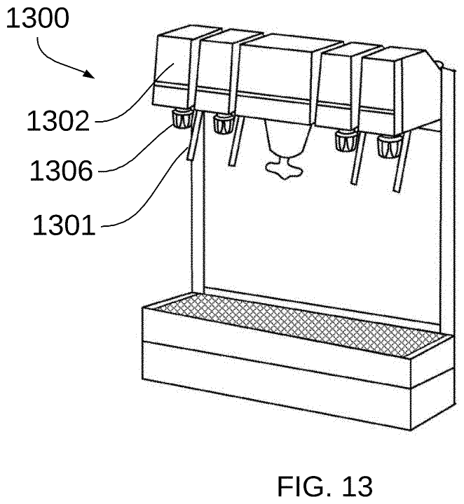

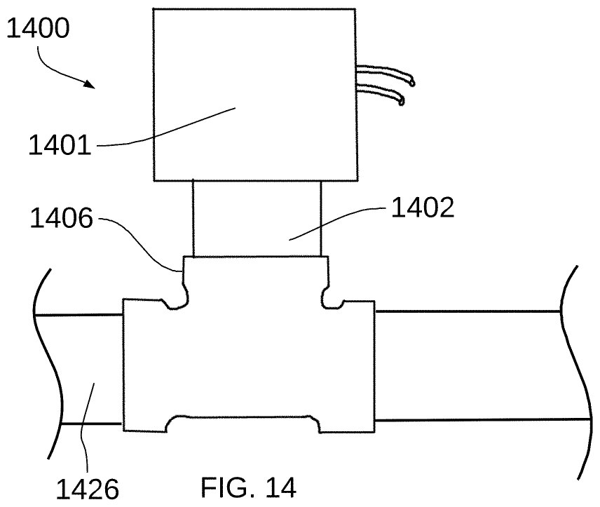

FIGS. 10-14 illustrate alternate embodiments of fluid monitoring and tracking device 1002-1402 (also known as “tracking device”) integrated in various fluid dispensing systems (1000-1400) to be connected to either a fluid container or to a conduit (1026-1426) that transports fluid. For example, the various fluid dispensing system may include a sprayer 1100 connected to a conduit 1126 for dispensing gardening or pest control chemicals (see FIG. 10), a gas station dispensing valve 1100 (see FIG. 11) for dispensing gasoline from a storage tank, a mechanical shut off valve connected to a conduit 1226 that transports gas or liquid (see FIG. 12), a beverage dispenser 1300 connected to a soda container (see FIG. 13) and a current controlled solenoid valve assembly 1400 connected to a conduit 1426 that transports gas or liquid (see FIG. 14).

As shown in each of the respective FIGS. 10-14, a tracking device (1002-1402) may be installed to detect a change of state (i.e., open state or shut state) in the respective valves (1006-1406) through respective triggering mechanisms (1001-1401) and to monitor and wirelessly communicate an amount of fluid flow in response to the respective triggering mechanisms. The respective triggering mechanism may be sensing one or a combination of signals generated from sensors previously described, including: accelerometer, magnetometer, gyroscope, biometric recognition, speech command, proximity, touch, pressure, temperature, light, RFID, geolocation.

Signals generated from sensors may be communicated wirelessly in one or more of the schemes previously described, including: in real-time, periodically, delayed, upon reaching a predetermined cumulative triggering events or a predetermined cumulative flow volume, in burst broadcast mode and encrypted.

Other systems, methods, features and advantages will be, or will become, apparent to one with skill in the art upon examination of the figures and detailed description. It is intended that all such additional systems, methods, features and advantages be included within this description, be within the scope of the disclosure, and be protected by the following claims.

We claim:

1. A method for monitoring fluid dispensing, comprising:
coupling a plurality of sensors to a valve of a fluid dispensing assembly, wherein the plurality of sensors are housed within a tracking device housing, wherein the fluid dispensing assembly comprises a dispenser body having an inlet and an outlet, the inlet of the dispenser body is configured to be connected either to a fluid container or to a conduit that transports fluid, and the valve is disposed between the inlet and the outlet, wherein the valve is configured to operate in either a first state or a second state to control fluid flow from the inlet to the outlet;
detecting a change of a state of the valve from the first state to the second state through detecting a sequence of first triggering events;
detecting a subsequent change of states of the valve from the second state back to the first state through detecting a sequence of second triggering events;
determining a first time duration ΔT₁ between two successive changes of the first states of the valve;
transmitting through a wireless transceiver, to one or both of an external user device and a remote central monitoring unit, first data from the detected sequence of first triggering events, second data from the detected sequence of second triggering events, the first time duration and a predetermined flow rate Q for a determination of a volume V of fluid being dispensed from the outlet of the fluid dispensing assembly.

2. The method of claim 1, wherein prior to the fluid dispensing and the detecting of the sequence of first triggering events, performing one or more of user's identity verification by performing the following on an accessory device coupled to the fluid dispensing assembly:
inputting user's biometric data on a biometric input device through detecting one of: finger prints, e-signature, voice signature;
scanning user's one-dimensional or two-dimensional (QR) barcode to a scanner;
using a near-field transponder to read a code from a user's RFID tag; and
receiving on a touch screen, one or both of user's finger gesture and a user's password.

3. The method of claim 1, wherein the detecting of the sequence of first triggering events or the sequence of second triggering events, comprising performing by the tracking device, one or more of:
detecting, by an accelerometer, any one of: a sudden change of a position of a movable structure of the fluid dispensing assembly, a sudden shock force of a movable structure of the fluid dispensing assembly and a sudden change in motion of a movable structure of the fluid dispensing assembly;
detecting, by a magnetometer, a change or disruption of existing magnetic field to the movable structure of the fluid dispensing assembly;
detecting, by a gyroscope, a tilt or a change of radial angle of the movable structure of the fluid dispensing assembly;
detecting, by a piezoelectric pressure sensor, an applied pressure formed by the movable structure of the fluid dispensing assembly;
detecting, by a thermocouple, temperature change of the housing which is in contact with the fluid dispensing assembly as a result of operating the movable structure of the fluid dispensing assembly; and
detecting, by a photodetector, a disruption to an intensity of an optical beam caused by the movable structure of the fluid dispensing assembly.

4. The method of claim 3, wherein the movable structure of the fluid dispensing assembly comprises any one of: a handle, a mechanical switch, a mechanical trigger, a lever, and a solenoid relay, and wherein the tracking device is either integrated within or externally attached to the fluid dispensing assembly.

5. The method of claim 1, wherein the change of states of the valve from the first state to the second state comprises changing from a shut state to an open state, and the change of states of the valve from the second state to the first state comprises changing from the open state to the shut state.

6. The method of claim 1, wherein the determination of the volume V of fluid being dispensed from the output portion of the fluid dispensing assembly, comprising taking a product of the first time duration ΔT₁ and the predetermined flow rate Q, or V=Q*ΔT₁.

7. The method of claim 2, wherein the wireless transceiver wakes up from a low power sleep mode upon detecting one or both of: the sequence of first triggering events and the verification of user's identity, and subsequent to the waking up, the wireless transceiver delays transmission to one or both of the external user device and the remote central monitoring unit until a buffer of the tracking device has reached a predetermined storage level as a result of successive counts of detection of the first data from the detected sequence of first triggering events, the second data from the detected sequence of second triggering events, and the first time duration ΔT₁.

8. A tracking device for monitoring fluid dispensing, comprising:
a plurality of sensors coupled to a valve of a fluid dispensing assembly, wherein the plurality of sensors are housed within a housing of the tracking device, wherein the fluid dispensing assembly comprises a dispenser body having an inlet and an outlet, the inlet of the dispenser body is configured to be connected either to a fluid container or to a conduit that transports fluid, and the valve is disposed between the inlet and the outlet, wherein the valve is configured to operate in either a first state or a second state to control fluid flow from the inlet to the outlet;
a processor, housed within the housing of the tracking device, that executes program code stored in a memory, wherein the program code when executed, causes the processor to configure the plurality of sensors to:
detect a change of state of the valve from the first state to the second state through detecting a sequence of first triggering events;
detect a subsequent change of states of the valve from the second state back to the first state through detecting a sequence of second triggering events;
determine one or both of: a first time duration ΔT₁ between two successive changes of the first states of the valve and a frequency of successive changes of the first states; and
a wireless transceiver, configured to transmit to one or both of: an external user device and a remote central monitoring unit:
first data from the detected sequence of first triggering events, second data from the detected sequence of second triggering events, the first time duration and a predetermined flow rate Q for a determination of a volume V of fluid being dispensed from the outlet of the fluid dispensing assembly.

9. The tracking device of claim 8, wherein prior to the fluid dispensing and the detecting of the sequence of first triggering events, the tracking device is configured to respond to user's identity verification on an accessory device coupled to the fluid dispensing assembly, wherein the user's identity verification comprises the accessory device being configured to:
receive an input of user's biometric data on a biometric input device through detecting one of: finger prints, e-signature, voice signature;
receive on a scanner, one of user's one-dimensional or two-dimensional (QR) barcode;
read by a near-field transponder, a code from a user's RFID tag; and
receive input on a touch screen, one or both of user's finger gesture and a user's password.

10. The tracking device of claim 8, wherein the detecting of the sequence of first triggering events or the sequence of second triggering events, comprising one or more of the plurality of sensors in the tracking device configured to:
detect by an accelerometer, any one of: a sudden change of a position of a movable structure of the fluid dispensing assembly, a sudden shock force of a movable structure of the fluid dispensing assembly and a sudden change in motion of a movable structure of the fluid dispensing assembly;
detect by a magnetometer, a change or disruption of existing magnetic field to the movable structure of the fluid dispensing assembly;
detect by a gyroscope, a tilt or a change of radial angle of the movable structure of the fluid dispensing assembly;
detect by a piezoelectric pressure sensor, an applied pressure formed by the movable structure of the fluid dispensing assembly;
detect by a thermocouple, temperature change of the housing which is in contact with the fluid dispensing assembly as a result of operating the movable structure of the fluid dispensing assembly; and
detect by a photodetector, a disruption to an intensity of an optical beam caused by the movable structure of the fluid dispensing assembly.

11. The tracking device of claim 10, wherein the movable structure of the fluid dispensing assembly comprises any one of: a handle, a mechanical switch, a mechanical trigger, a lever, and a solenoid relay, and wherein the tracking device is either integrated within or externally attached to the fluid dispensing assembly.

12. The tracking device of claim 8, wherein the change of states of the valve from the first state to the second state comprises changing from a shut state to an open state, and the change of states of the valve from the second state to the first state comprises changing from the open state to the shut state.

13. The tracking device of claim 8, wherein the determination of the volume V of fluid being dispensed from the output portion of the fluid dispensing assembly, comprising taking a product of the first time duration ΔT₁ and the predetermined flow rate Q, or V=Q*ΔT₁.

14. The tracking device of claim 9, wherein the wireless transceiver wakes up from a low power sleep mode upon detecting one or both of: the sequence of first triggering events and the verification of user's identity, and subsequent to the waking up, the wireless transceiver delays transmission to one or both of the external user device and the remote central monitoring unit until a buffer of the tracking device has reached a predetermined storage level as a result of successive counts of detection of the first data from the detected sequence of first triggering events, the second data from the detected sequence of second triggering events, and the first time duration ΔT₁.

15. A fluid dispensing assembly that monitors fluid dispensing, comprising:
a dispenser body having an inlet and an outlet, wherein the inlet of the dispenser body is configured to be connected either to a fluid container or to a conduit that transports fluid;
a valve disposed between the inlet and the outlet, wherein the valve is configured to operate in either a first state or a second state to control fluid flow from the inlet to the outlet;
a tracking device having:
a plurality of sensors housed within a housing of the tracking device, wherein the plurality of sensors are coupled to the valve;
a processor, housed within the housing of the tracking device, that executes program code stored in a memory, wherein the program code when executed, causes the processor to configure the plurality of sensors to:
detect a change of state of the valve from the first state to the second state through detecting a sequence of first triggering events;
detect a subsequent change of states of the valve from the second state back to the first state through detecting a sequence of second triggering events;
determine one or both of: a first time duration ΔT₁ between two successive changes of the first states of the valve and a frequency of successive changes of the first states; and
a wireless transceiver, configured to transmit to one or both of: an external user device and a remote central monitoring unit:
first data from the detected sequence of first triggering events, second data from the detected sequence of second triggering events, the first time duration and a predetermined flow rate Q for a determination of a volume V of fluid being dispensed from the outlet of the fluid dispensing assembly.

16. The fluid dispensing assembly of claim 15, comprising an accessory device coupled to the fluid dispensing assembly, wherein prior to the fluid dispensing and the detecting of the sequence of first triggering events, the tracking device is configured to respond to user's identity verification on the accessory device, wherein the user's identity verification comprises the accessory device being configured to:
receive an input of user's biometric data on a biometric input device through detecting one of: finger prints, e-signature, voice signature;
receive on a scanner, one of user's one-dimensional or two-dimensional (QR) barcode;
read by a near-field transponder, a code from a user's RFID tag; and
receive input on a touch screen, one or both of user's finger gesture and a user's password.

17. The fluid dispensing assembly of claim 15, wherein the detecting of the sequence of first triggering events or the sequence of second triggering events, comprising one or more of the plurality of sensors in the tracking device configured to:
detect by an accelerometer, any one of: a sudden change of a position of a movable structure of the fluid dispensing assembly, a sudden shock force of a movable structure of the fluid dispensing assembly and a sudden change in motion of a movable structure of the fluid dispensing assembly;
detect by a magnetometer, a change or disruption of existing magnetic field to the movable structure of the fluid dispensing assembly;
detect by a gyroscope, a tilt or a change of radial angle of the movable structure of the fluid dispensing assembly;
detect by a piezoelectric pressure sensor, an applied pressure formed by the movable structure of the fluid dispensing assembly;
detect by a thermocouple, temperature change of the housing which is in contact with the fluid dispensing assembly as a result of operating the movable structure of the fluid dispensing assembly; and
detect by a photodetector, a disruption to an intensity of an optical beam caused by the movable structure of the fluid dispensing assembly.

18. The fluid dispensing assembly of claim 17, wherein the movable structure of the fluid dispensing assembly comprises any one of: a handle, a mechanical switch, a mechanical trigger, a lever, and a solenoid relay, and wherein the tracking device is either integrated within or externally attached to the fluid dispensing assembly.

19. The fluid dispensing assembly of claim 15, wherein the change of states of the valve from the first state to the second state comprises changing from a shut state to an open state, and the change of states of the valve from the second state to the first state comprises changing from the open state to the shut state.

20. The fluid dispensing assembly of claim 15, wherein the determination of the volume V of fluid being dispensed from the output portion of the fluid dispensing assembly, comprising taking a product of the first time duration ΔT₁ and the predetermined flow rate Q, or V=Q*ΔT₁.

21. The fluid dispensing assembly of claim 16, wherein the wireless transceiver wakes up from a low power sleep mode upon detecting one or both of: the sequence of first triggering events and the verification of user's identity, and subsequent to the waking up, the wireless transceiver delays transmission to one or both of the external user device and the remote central monitoring unit until a buffer of the tracking device has reached a predetermined storage level as a result of successive counts of detection of the first data from the detected sequence of first triggering events, the second data from the detected sequence of second triggering events, and the first time duration ΔT₁.
